(19) United States
(12) Patent Application Publication
(10) Pub. No.: US 2015/0348119 A1
(43) Pub. Date: Dec. 3, 2015

(54) METHOD AND SYSTEM FOR TARGETED ADVERTISING BASED ON ASSOCIATED ONLINE AND OFFLINE USER BEHAVIORS

(71) Applicant: Videology Inc., Baltimore, MD (US)

(72) Inventors: Scott Andrew Ferber, Bethesda, MD (US); Aleck Howard Schleider, Reisterstown, MD (US)

(73) Assignee: Videology Inc., Baltimore, MD (US)

(21) Appl. No.: 14/289,550

(22) Filed: May 28, 2014

(51) Int. Cl. G06Q 30/02; H04L 29/08

(52) U.S. Cl. CPC G06Q 30/0269; G06Q 30/0246; H04L 67/22

(57) ABSTRACT

Methods, systems, and programming for targeted advertising and conversion measurement. In one example, first information related to an online activity of a user is received. The online activity is associated with a first attribute to be used to identify the user. Second information related to an offline activity of the user is received. The offline activity is associated with a second attribute to be used to identify the user. A connection between the online activity and the offline activity of the user is then identified by matching the first attribute with the second attribute. A profile of the user is obtained based, at least in part, on the identified connection. A request of serving an advertisement is received. The user is selected from a plurality of users based on the profile of the user and information related to the request. The advertisement is provided to the user.

### CROSS-REFERENCE TO RELATED APPLICATION

The present application is related to a U.S. patent application having an attorney docketing No. 022999-0428392, filed on even date, entitled METHOD AND SYSTEM FOR RECOMMENDING TARGETED TELEVISION PROGRAMS BASED ON ONLINE BEHAVIOR, a U.S. patent application having an attorney docketing No. 022999-0428404, filed on even date, entitled METHOD AND SYSTEM FOR ADVERTISEMENT CONVERSION MEASUREMENT BASED ON ASSOCIATED DISCRETE USER ACTIVITIES, and a U.S. patent application having an attorney docketing No. 022999-0428405, filed on even date, entitled METHOD AND SYSTEM FOR ASSOCIATING DISCRETE USER ACTIVITIES ON MOBILE DEVICES, all of which are incorporated herein by reference in their entireties.

### BACKGROUND

1. Technical Field

The present teaching relates to methods and systems for advertising. Specifically, the present teaching relates to methods and systems for targeted advertising and conversion measurement.

2. Discussion of Technical Background

The rapid development of digital content access platforms, such as the Internet, mobile Internet, and smart TV, has made it possible for a user to electronically access virtually any content at any time from any location using any device. Such free access to digital content without limitations in time, space, or platforms has enabled great opportunity for advertisers and publishers in advertising. On the other hand, with the explosion of information, it has become increasingly important to provide users with advertisement that is relevant to the user.

Efforts have been made to attempt to deliver advertisements to targeted users who are most likely interested in the advertisements. A shortcoming of the traditional approaches is that it merely aggregates user activities on a particular platform while a user's everyday life spans across multiple platforms. For example, users' explicit interests (e.g., user's preferences declared in social networks) or implicit interests (e.g., interests inferred by analyzing the user's online content consumption) have been collected online and used as a basis for targeted advertising by known approaches. However, online behaviors constitute only a portion of a user's daily activities, which, sometimes, are insufficient to build a comprehensive and accurate user profile for the purpose of targeted advertising. This is particularly true for certain users, who are not used to using the Internet, such as elderly people. Even on the same platform, e.g., online platform, a user's activities also span cross different devices, which makes the traditional approaches even more ineffective in capturing the user's online behaviors to build a comprehensive and accurate user profile. For example, traditional approaches rely primarily on cookies in tracking users' online activities. However, these approaches are no longer suitable in today's mobile world as mobile devices usually do not have reliable cookies. As another example on the TV platform, there is currently no way to use online digital data, such as media consumption and transaction data, to create personalized TV programs to appropriate audiences.

Another line of efforts in attempting to optimize targeted advertising have been made to measure the advertisement conversion rate, which is the rate at which an advertisement exposure event leads to a corresponding advertisement conversion event. The underlying goal is to provide an indicator to the marketers, e.g., advertisers or publishers, regarding the effectiveness of their advertisements, advertisement placements, etc. The convergence of consumer devices over the past several years has created a situation where the average consumer digests media from multiple devices at different platforms (e.g., online, offline, TV, etc.) on a daily basis. For example, different activities may be performed on different devices or platforms, e.g., being exposed to an advertisement of a product on one device but making online purchase of the advertised product on another device. Sometimes, the purchase may even be made offline, e.g., at a local store. In addition, as there is a gap in time between viewing an advertisement and the actual transaction caused by the advertisement, it is even harder to link the viewing activity and purchasing activity across time. Furthermore, one user in a user group, e.g., a household, may be exposed to an advertisement but a different user from the same user group may make the purchase. These create difficulties in estimating the conversion rate of an advertisement.

Traditional approaches, however, are unable to handle the difficulties as they evaluate advertisement conversion at each platform separately to judge effectiveness or, more commonly, use guesstimate to approximate their return on investment (ROI) on advertisement spending. For example, advertisers traditionally utilize modeling and assumptions to track the effectiveness of their campaigns, often using metrics such as click through rate (CTR) to approximate sales. However, the use of CTR or other traditionally-utilized often produce inaccurate information regarding the effectiveness of the advertising campaigns and, as a result, inhibit the ability of advertisers (or other entities) to optimize advertisement spending.

Therefore, there is a need for improvements over the conventional approaches to providing targeted advertisement and conversion measurement.

### SUMMARY

The present teaching relates to methods and systems for advertising. Specifically, the present teaching relates to methods and systems for targeted advertising and conversion measurement.

In one example, a method, implemented on at least one machine, each having at least one processor, storage, and a communication platform connected to a network for targeted advertising is presented. First information related to an online activity of a user is received. The online activity is associated with a first attribute to be used to identify the user. Second information related to an offline activity of the user is received. The offline activity is associated with a second attribute to be used to identify the user. A connection between the online activity and the offline activity of the user is then identified by matching the first attribute with the second attribute. A profile of the user is obtained based, at least in part, on the identified connection. A request of serving an advertisement is received. The user is selected from a plurality of users based on the profile of the user and information related to the request. The advertisement is provided to the user.

In another example, a method, implemented on at least one machine, each having at least one processor, storage, and a communication platform connected to a network for advertisement conversion measurement is presented. A request of serving an advertisement is received. The advertisement is provided to a user based on information related to the request and a profile of the user. The user is associated with a first identifier. Information related to offline activities of the user is received. Each of the offline activities is identified based on the first identifier associated with the user. At least one offline activity of the user is identified from the received information. The at least one offline activity relates to an event associated with the advertisement. A measure of serving the advertisement is determined based on the identified at least one offline activity of the user.

In a different example, a system having at least one processor, storage, and a communication platform for targeted advertising is presented. The system includes an online events processing module, an offline events processing module, an online-offline events matching module, an online-offline data mining module, and an advertisement serving module. The online events processing module is configured to receive first information related to an online activity of a user. The online activity is associated with a first attribute to be used to identify the user. The offline events processing module is configured to receive second information related to an offline activity of the user. The offline activity is associated with a second attribute to be used to identify the user. The online-offline events matching module is configured to identify a connection between the online activity and the offline activity of the user by matching the first attribute with the second attribute. The online-offline data mining module is configured to obtain a profile of the user based, at least in part, on the identified connection. The advertisement serving module is configured to receive a request of serving an advertisement, select the user from a plurality of users based on the profile of the user and information related to the request, and provide the advertisement to the user.

In another example, a system having at least one processor, storage, and a communication platform for advertisement conversion measurement is presented. The system includes an advertisement serving module, an offline events processing module, an events matching module, and an advertisement conversion measurement module. The advertisement serving module is configured to receive a request of serving an advertisement and provide the advertisement to a user based on information related to the request and a profile of the user. The user is associated with a first identifier. The offline events processing module is configured to receive information related to offline activities of the user. Each of the offline activities is identified based on the first identifier associated with the user. The events matching module is configured to identify at least one offline activity of the user from the received information. The at least one offline activity relates to an event associated with the advertisement. The advertisement conversion measurement module is configured to determine a measure of serving the advertisement based on the identified at least one offline activity of the user.

Other concepts relate to software for targeted advertising and conversion measurement. A software product, in accord with this concept, includes at least one non-transitory machine-readable medium and information carried by the medium. The information carried by the medium may be executable program code data regarding parameters in association with a request or operational parameters, such as information related to a user, a request, or a social group, etc.

In one example, a non-transitory machine readable medium having information recorded thereon for targeted advertising is presented. The recorded information, when read by the machine, causes the machine to perform a series of steps. First information related to an online activity of a user is received. The online activity is associated with a first attribute to be used to identify the user. Second information related to an offline activity of the user is received. The offline activity is associated with a second attribute to be used to identify the user. A connection between the online activity and the offline activity of the user is then identified by matching the first attribute with the second attribute. A profile of the user is obtained based, at least in part, on the identified connection. A request of serving an advertisement is received. The user is selected from a plurality of users based on the profile of the user and information related to the request. The advertisement is provided to the user.

In another example, a non-transitory machine readable medium having information recorded thereon for advertisement conversion measurement is presented. The recorded information, when read by the machine, causes the machine to perform a series of steps. A request of serving an advertisement is received. The advertisement is provided to a user based on information related to the request and a profile of the user. The user is associated with a first identifier. Information related to offline activities of the user is received. Each of the offline activities is identified based on the first identifier associated with the user. At least one offline activity of the user is identified from the received information. The at least one offline activity relates to an event associated with the advertisement. A measure of serving the advertisement is determined based on the identified at least one offline activity of the user.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary system diagram for serving advertisement based on integrated data mining, according to an embodiment of the present teaching;

FIG. 2 illustrates exemplary discrete user events over time and across different platforms;

FIG. 3 is a high level exemplary system diagram of the integrated data mining mechanism shown in FIG. 1, according to an embodiment of the present teaching;

FIG. 4 depicts an exemplary diagram of an events processing engine in the system shown in FIG. 3, according to an embodiment of the present teaching;

FIG. 5 depicts an exemplary diagram of an events grouping engine in the system shown in FIG. 3, according to an embodiment of the present teaching;

FIG. 6 depicts exemplary diagrams of a data mining engine and a service engine in the system shown in FIG. 3, according to an embodiment of the present teaching;

FIG. 7 depicts an exemplary diagram of a system for targeted advertising based on associated online and offline behaviors, according to an embodiment of the present teaching;

FIG. 8 is a flowchart of an exemplary process for targeted advertising based on associated online and offline behaviors, according to an embodiment of the present teaching;

FIG. 9 is a flowchart of another exemplary process for targeted advertising based on associated online and offline behaviors, according to an embodiment of the present teaching;

FIG. 10 depicts an exemplary diagram of a system for advertisement conversion measurement based on associated online and offline behaviors, according to an embodiment of the present teaching;

FIG. 11 is a flowchart of an exemplary process for advertisement conversion measurement based on associated online and offline behaviors, according to an embodiment of the present teaching;

FIG. 12 depicts an exemplary diagram of a system for advertisement conversion measurement based on discrete user activities on mobile devices, according to an embodiment of the present teaching;

FIG. 13 depicts an exemplary diagram of a mobile events processing module in the system shown in FIG. 12, according to an embodiment of the present teaching;

FIG. 14 is a flowchart of an exemplary process for advertisement conversion measurement based on discrete user activities on mobile devices, according to an embodiment of the present teaching;

FIG. 15 is a flowchart of an exemplary process for advertisement conversion measurement based on discrete user activities on mobile devices and offline user activities, according to an embodiment of the present teaching;

FIG. 16 is a flowchart of an exemplary process for associating discrete user online activities on mobile devices, according to an embodiment of the present teaching;

FIG. 17 is a flowchart of another exemplary process for associating discrete user online activities on mobile devices, according to an embodiment of the present teaching;

FIG. 18 depicts a general mobile device architecture on which the present teaching can be implemented; and

FIG. 19 depicts a general computer architecture on which the present teaching can be implemented.

### DETAILED DESCRIPTION

In the following detailed description, numerous specific details are set forth by way of examples in order to provide a thorough understanding of the relevant teachings. However, it should be apparent to those skilled in the art that the present teaching may be practiced without such details. In other instances, well known methods, procedures, components, and/or circuitry have been described at a relatively high-level, without detail, in order to avoid unnecessarily obscuring aspects of the present teaching.

One aspect of the present teaching is to improve the accuracy of estimating conversion rates by recognizing seemingly discrete activities performed by different users or on different devices/platforms, and linking them to the underlying advertisement that was exposed and subsequently led to the corresponding conversion activities. For example, the present teaching is able to link together these disparate elements into a common framework and measure offline transactions from cross-device advertisement exposure to enable marketers (e.g., advertisers, publishers, etc.) to maximize the return on their marketing investments. The marketers are able to find out how actual sales of product or service are impacted or driven by specific types of advertisements or platforms on which advertisements are served. The present teaching thus allows the marketers to correlate e-commerce and offline sales to specific users or user groups and campaigns in order to better understand the relationship between advertisement investment and revenue.

Another aspect of the present teaching is to create personal identifications that persist across time with respect to each user of mobile devices, for example, in the absence of cookies so that the conversion rate in the mobile space can be more accurately estimated. For example, whenever a user is exposed to an advertisement, information regarding the user's device, IP address, etc., may be obtained (e.g., device identifier, browser identifier, IP address, etc.). Such information may be used to generate a unique identifier for the user, and the unique identifier may be stored with information about the exposure of the advertisement. When an online conversion relating to the advertisement occurs at a later time, information regarding the user's device, IP address, etc., may again be obtained and used to generate another unique identifier. To compute the conversion rates, information on both advertisement exposures and conversions are retrieved and processed. Via the unique user identifiers (e.g., associated with exposures, associated with conversions, etc.), the conversion rates can be estimated by matching the unique identifiers associated with exposure data and the unique identifiers associated with conversion data.

Still another aspect of the present teaching is to plan and create personalized TV programs to appropriate audiences based on online and/or offline digital data collected from different digital data sources. The association between digital data and TV media consumption data allows devising useful information, such as who watches what on TV and consumes what online media and/or offline purchases, etc. Data analytics of such useful information can be used for future TV program planning by the TV program operators with respect to different audience based on online/offline digital data. In addition to benefiting TV program planning, the meaningful linkage between digital data and TV consumption data can also benefit other parties, including publishers and advertisers. For example, based on online digital data and TV consumption data, recommendations may be provided to advertisers regarding TV programs in which certain advertisements are to be incorporated, the regions in which certain advertisements are to be shown, and/or the audiences for which certain advertisements are to be presented. In addition, based on digital data and TV consumption data, recommendations may also be provided to content providers as to what media are more perceptive in which region and/or for which audience.

Additional novel features will be set forth in part in the description which follows, and in part will become apparent to those skilled in the art upon examination of the following and the accompanying drawings or may be learned by production or operation of the examples. The novel features of the present teaching may be realized and attained by practice or use of various aspects of the methodologies, instrumentalities and combinations set forth in the detailed examples discussed below.

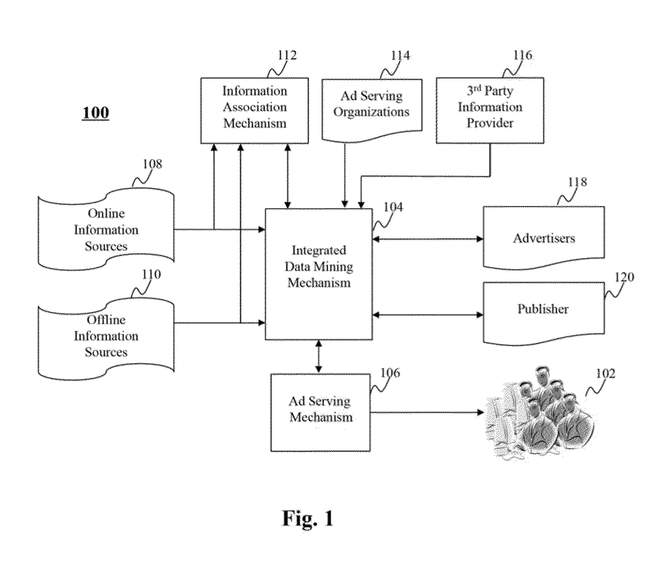

FIG. 1 depicts an exemplary system 100 for serving advertisements to users 102 based on integrated data mining, according to an embodiment of the present teaching. The system 100 comprises an integrated data mining mechanism 104, an advertisement serving mechanism 106, online information sources 108, offline information sources 110, an information association mechanism 112, advertisement serving organizations 114, 3^{rd} party information providers 116, advertisers 118, and publishers 120.

Online information sources 108 may comprise any online platform on which user activities occur. User activities may comprise exposure events, conversion events, or other user activities. An exposure event may comprise consumption, either actively or passively by a user, of a piece of content, such as an advertisement or a TV program. Thus, an exposure event may also be considered a media consumption event. Examples of online advertising include contextual ads on search engine result pages, banner ads, blogs, rich media ads, interstitial ads, online classified advertising, advertising networks, and e-mail marketing. A conversion event may comprise any event that is triggered by a prior exposure event, such as a transaction that is motivated by viewing the corresponding advertisement. In another example, navigating to the advertiser's website by clicking links on the corresponding advertisement may also be a conversion event.

Additionally, or alternatively, online information sources 108 may comprise content providers, such as publishers or content distributors, where online exposure events occur. The content provides may be, for example, Yahoo!, Google, Facebook, CNN, ESPN, etc. The online information sources 108 may also include online service providers, such as e-commerce operators or e-logistics operators, where online conversion events happen. The online service providers include, for example, Amazon.com, Ebay.com, Wayfair.com, Hayneedle.com, to name a few. It is understood that, some websites may act as both online content providers and service provider as both exposure and conversion events may occur on the same website. For example, Amazon.com provides personalized product recommendations to a user, which is considered as an exposure event; the user may decide to purchase one of the recommend products at Amazon.com, which is a conversion event at the same source.

Offline information sources 110 may comprise any offline platform on which user activities occur. The offline information sources 110 may comprise retailers, such as local stores of Walmart, Whole Foods, Apple, automotive dealers, movie theaters, pharmacies, travel agencies, etc. The offline information sources 110 may also include financial institutes, such as banks, credit card companies, or insurance companies. In addition, the offline information sources 110 may include 3^{rd} party clearance houses or 3^{rd} party logistics operators. Offline user conversion events may occur and be recorded in an offline information source 110. For example, a user may purchase an advertised product at a local store using his/her credit card and opt to ship the product to his/her parents at another state. The offline conversion event may thus occur at the local retailer, and its associated information may be recorded by and retrieved from the retailer, the credit card company, or the shipping carrier. In addition to offline conversion events, exposure or media consumption events may also occur offline, in the forms of, for example, in-store advertisement or billboard advertisement. It is understood that, some entities may be both online information sources 108 and offline information sources 110. For example, the local stores of Walmart are considered as offline information sources 110 while its e-commerce website (Walmart.com) is an online information source 108.

Information about users' online and offline activities, e.g., user events, may be continuously or periodically monitored and fed into the integrated data mining mechanism 104 for associating related user events, regardless of when, where, and how the events occur, making the associations meaningful through data mining, and eventually utilizing the data mining results to optimize the advertisement serving. In this embodiment, the association of related user events may also be performed by the information association mechanism 112 that is independent of the integrated data mining mechanism 104. The information association mechanism 112 may be an entity that is dedicated on matching purchase events at different platforms for the same person or household based on, for example, personally identifiable information (PII) or physical address. The matched events may be provided to the integrated data mining mechanism 104 by the information association mechanism 112 as a service. In addition to information about related user events, information about a user, e.g., user demographic information or behavior information may be also fed into the integrated data mining mechanism 104 from the 3^{rd} party information provider 116. Both user information and events association information may be used by the integrated data mining mechanism 104 in user profiling and targeted advertising.

One of the applications of the integrated data mining mechanism 104 includes targeted advertising. This may be performed in conjunction with the advertisement serving mechanism 106 in response to a request from the advertisers 118, publisher 120, or advertisement serving organizations 114. An advertiser 118, such as a manufacturer, a dealer, or an agent, may send an advertisement serving request to the integrated data mining mechanism 104 either directly, or through a publisher 120 (where the advertisement is to be presented) or a dedicated advertisement serving organization 114. Based on the received request, the integrated data mining mechanism 104 may identify the targeted users based on previously-created user profiles, which were created based on information from the online information sources 108, offline information sources 110, information from the information association mechanism 112, and/or information from the 3^{rd} party information provider 116. On the other hand, the integrated data mining mechanism 104 may also track the behaviors of the targeted uses after they have been exposed with the advertisement and provide advertisement conversion measurement to the advertisers 118 and/or publishers 120 based on the tracked user behaviors as feedback to determine the effectiveness of the served advertisement.

The system 100 in FIG. 1 may be implemented in a networked environment in which some or all of the components/parties are connected through one or more networks. The network(s) may be a single network or a combination of different networks. For example, the network(s) may be a local area network (LAN), a wide area network (WAN), a public network, a private network, a proprietary network, a Public Telephone Switched Network (PSTN), the Internet, a wireless network, a virtual network, or any combination thereof. The network(s) may also include various network access points, e.g., wired or wireless access points such as base stations or Internet exchange points through which a data source may connect to the network(s) in order to transmit information via the network(s).

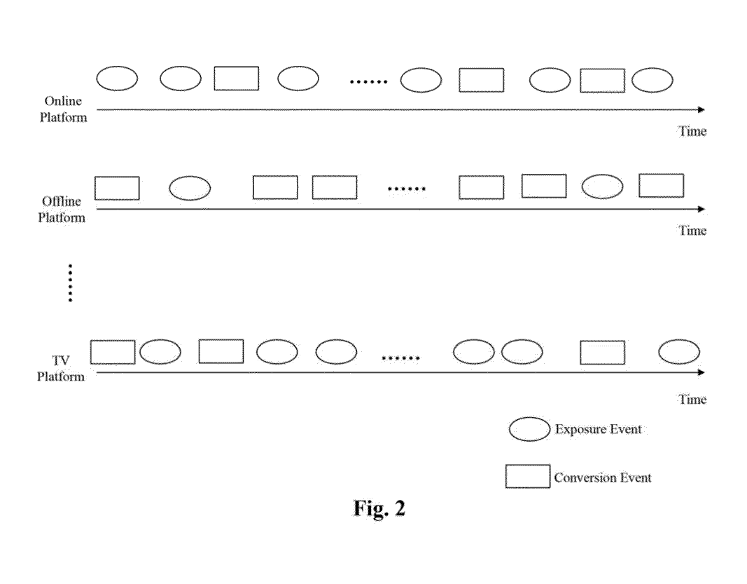

FIG. 2 illustrates exemplary discrete user events over time and across different platforms that may be detected and utilized in targeted advertising and conversion measurement. Each user event is associated with a particular user by which an activity with respect to a piece of content, e.g., an advertisement, is performed. In this illustration, user events may be either exposure events or conversion events. An exposure event may comprise consumption, either actively or passively by a user, of a piece of content, such as an advertisement or a television program. Thus, an exposure event may also be considered a media consumption event. A conversion event may comprise any event that is triggered by a prior exposure event, such as a transaction that is motivated by viewing the corresponding advertisement. In another example, navigating to the advertiser's website by clicking links on the corresponding advertisement may also be a conversion event. Thus, each conversion event may also be associated with a piece of content by which the conversion event is triggered, such as an advertisement.

The user events are discrete events at different dimensions, including user, time, space, platform, devices, or other dimensions. As shown in FIG. 2, user events may occur at different platforms, such as online platform, offline platform, TV platform, etc. Even on the same platform, user events may also occur on different devices. For example, a user may view an online advertisement on a PC, a laptop, a smartphone, or a tablet. As to the time dimension, each discrete event may occur at various time spans, for example, an hour, a day, a week, or even a year. Despite their occurrences among the different dimensions, user events may correspond with each other if, for instance, they are associated with the same user/user group or content. For example, a wife receives an e-mail advertisement of the newly released iPad mini and then tells her husband about it at dinner. One week later, the husband purchases the iPad mini at a local Apple Store as a birthday gift for the wife. The two events (viewing the e-mail advertisement and making the purchase at the local store) are discrete as they occurred at different times, on different platforms, and are associated with different persons. However, they have strong connections in targeted advertising, in particular, for measuring the effectiveness of the e-mail advertisement. The connections between discrete events shown in FIG. 2 can be identified by the integrated data mining mechanism 104 and utilized for various applications in advertisement serving optimization, such as user profiling, advertisement profiling, targeted advertising, and advertisement conversion measurement.

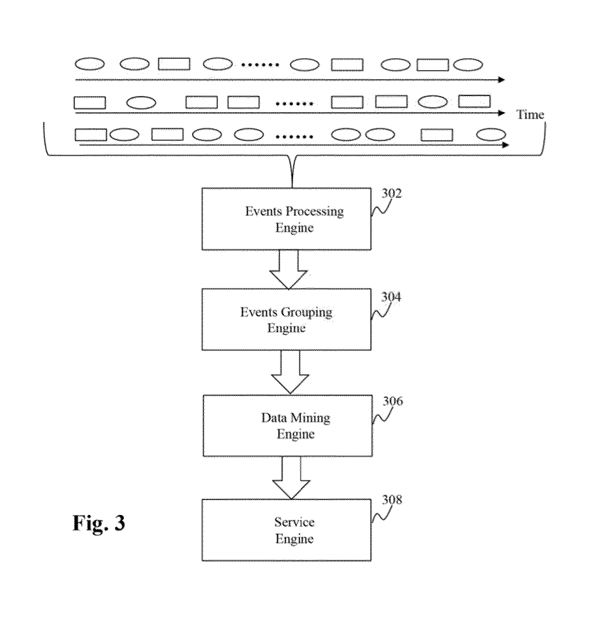

FIG. 3 is a high level exemplary system diagram of the integrated data mining mechanism 104, according to an embodiment of the present teaching. The integrated data mining mechanism 104 may include an events processing engine 302, an events grouping engine 304, a data mining engine 306, and a service engine 308. The events processing engine 302 interfaces with discrete events over time and across different platforms as illustrated above in FIG. 2. For each detected event, the events processing engine 302 identifies the user and/or the content that is associated with the event and creates an identifier (ID) for each of the events based on the user and/or the associated content. The events processing engine 302 may further identify the type of the event, e.g., an exposure event or a conversion event, or any other information associated with the event, e.g., the time, platform, device, etc. In other words, each user event can be digitalized by the events processing engine 302 and become an event ID associated with any related data. The processed events (event IDs with associated data) may be stored in a database and retrieved by the events grouping engine 304. The events grouping engine 304 then groups the processed events based on various criteria, such as the same user or user group or the same exposure content (e.g., the same advertisement). That is, discrete events that can be associated in different dimensions are identified and grouped by the events grouping engine 304 for further analysis. As described below in detail, a comprehensive analysis of the grouped events is performed by the data mining engine 306 to obtain meaningful information. The data mining results are fed into the service engine 308, which applies the meaningful information for different applications in advertisement serving optimization, such as user profiling, advertisement profiling, targeted advertising, and advertisement conversion measurement.

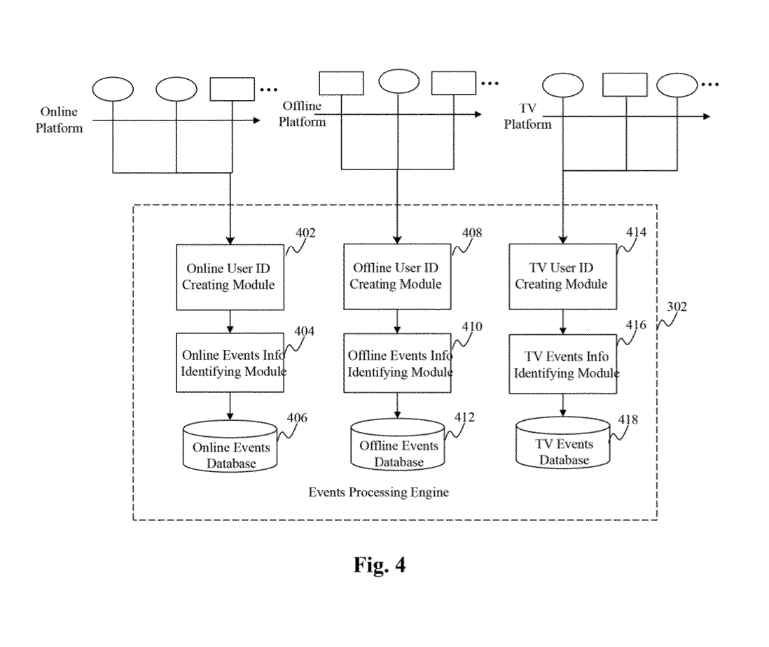

FIG. 4 depicts an exemplary diagram of the events processing engine 302 in the system shown in FIG. 3, according to an embodiment of the present teaching. In this embodiment, although only events from online, offline, and TV platforms are illustrated, it is understood that user events from any other platforms may be processed by the events processing engine 302 in the similar manner as illustrated in this FIG. 4. In this embodiment, the events processing engine 302 includes an online user ID creating module 402, an online events information identifying module 404, and an online events database 406 for processing user events detected on the online platform. The online user ID creating module 402 creates a user ID for each event occurring online based on one or more attributes of the events, for example, user-related or device-related information (e.g., cookie, IP address, user account, device ID, etc.). In one example, the online user ID creating module 402 may comprise an application embedded in a webpage, which automatically creates a unique code for each detected user activity that occurs on the webpage based on user-related or device-related information. The online events information identifying module 404 identifies or retrieves information associated with each detected online event. The information includes, but is not limited to, the time at which the event occurs, the user who performs the activity, the device on which the event occurs, the type of the event (e.g., an exposure or conversion event), content associated with the event (e.g., advertisement, news articles, blog posts, etc.), and the online information source (e.g., webpage). The created online user ID is then associated with the identified online events information and stored into the online events database 406.

Similarly, for user events detected on the offline platform, the events processing engine 302 may include an offline user ID creating module 408, an offline events information identifying module 410, and an offline events database 412. In an embodiment, the offline user ID creating module 408 is responsible for generating an offline user ID for each offline activity based on user-related information, such as PII. The offline events information identifying module 410 identifies or retrieves information associated with each detected offline event. The information includes, but is not limited to, the time at which the event occurs, the user who performs the activity, the locale at which the event occurs, the type of the event (e.g., exposure or conversion event), and content associated with the event (e.g., advertisement, news articles, blog posts, etc.). The created offline user ID is then associated with the identified offline events information and stored into the offline events database 412. In another example, processing of offline user events may be performed by an information association mechanism 112 that is independent of the integrated data mining mechanism 104. In that situation, the integrated data mining mechanism 104 may have an agreement with the information association mechanism 112 to access its offline events database.

For user events detected on the TV platform, the events processing engine 302 may include a TV user ID creating module 414, a TV events information identifying module 416, and a TV events database 418. In an embodiment, the TV user ID creating module 414 is responsible for generating a TV user ID for each TV activity. In one example, the TV user ID creating module 414 may be part of a set-top box, and may monitor and collect user behaviors on the TV platform. The TV events information identifying module 416 and TV events database 418 may also be part of the set-top box, and may identify or retrieve information associated with each detected TV event and store the TV user ID with associated information, respectively.

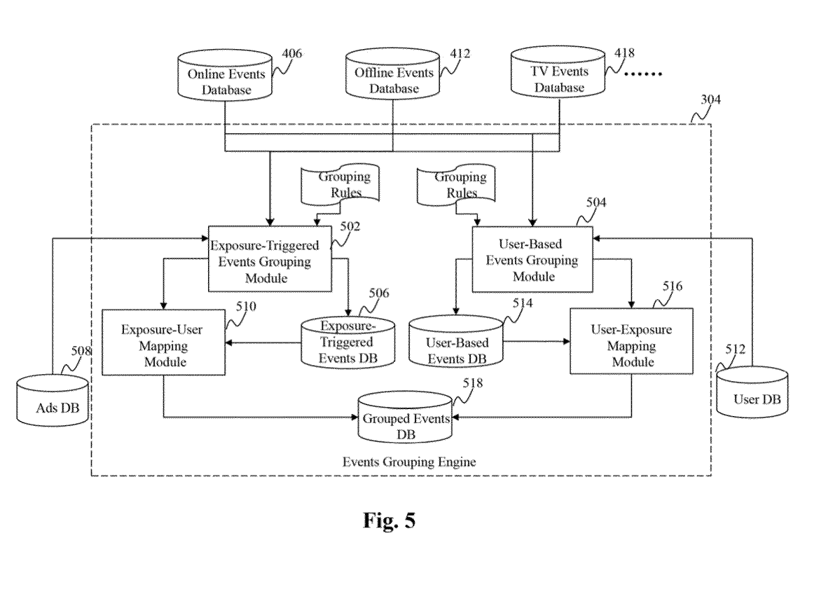

FIG. 5 depicts an exemplary diagram of the events grouping engine 304 in the system shown in FIG. 3, according to an embodiment of the present teaching. As illustrated, information from the online events database 406, offline events database 412, and TV events database 418 is fed into the events grouping engine 304 for identifying connections between the processed discrete events. The events grouping engine 304 in this embodiment includes an exposure-triggered events grouping module 502 and a user-based events grouping module 504. For the exposure-triggered events grouping module 502, the grouping is performed to identify all the events that are related to the same exposure content based on predefined grouping rules. In one example, exposure events related to the same exposure content (e.g., the same advertisement presented to different users on different platforms at different times) are grouped together and saved into the exposure-triggered events database 506. The grouped events may be saved in in association with previously-created user IDs. In another example, conversion events that are triggered by the same exposure content (e.g., transactions of a product or a service that is in the advertisement) may be grouped together. In still another example, exposure and conversion events that are related to the same exposure content are grouped together by the exposure-triggered events grouping module 502. In this embodiment, advertisement information is retrieved from an advertisement database 508 by the exposure-triggered events grouping module 502 in order to perform grouping based on the same exposed advertisement. In this embodiment, a second-stage grouping at the user level may be further conducted by an exposure-user mapping module 510, for example, when the first-stage grouping performed by the exposure-triggered events grouping module 502 does not distinguish different users associated with the grouped events. At this stage, events are further divided into sub-groups, each of which is associated with the same user or user group (e.g., household).

The user-based events grouping module 504, on the other hand, performs a user-based grouping at the first-stage based on predefined grouping rules. In one example, all the events associated with the same user are clustered by the user-based events grouping module 504 in conjunction with a user database 512, regardless of the time, platform, device, or the associated content, and are stored into the user-based events database 514. In another example, the user-based grouping may be performed for the household level such that all the events related to members of the same household are grouped. In still another example, other user groups, such as the same demographic group, the same social group, etc., may be used as a basis for user-based events grouping. In any event, a second-stage grouping based on the same associated content, e.g., advertisement, may be also conducted by a user-exposure mapping module 516 to further divide the user groups into sub-groups, each of which is related to the same content. Eventually, the sub-groups obtained from the exposure-user mapping module 510 and/or the user-exposure mapping module 516 are stored in the grouped events database 518. Each sub-group includes events associated with the same user/user group and the same exposure content.

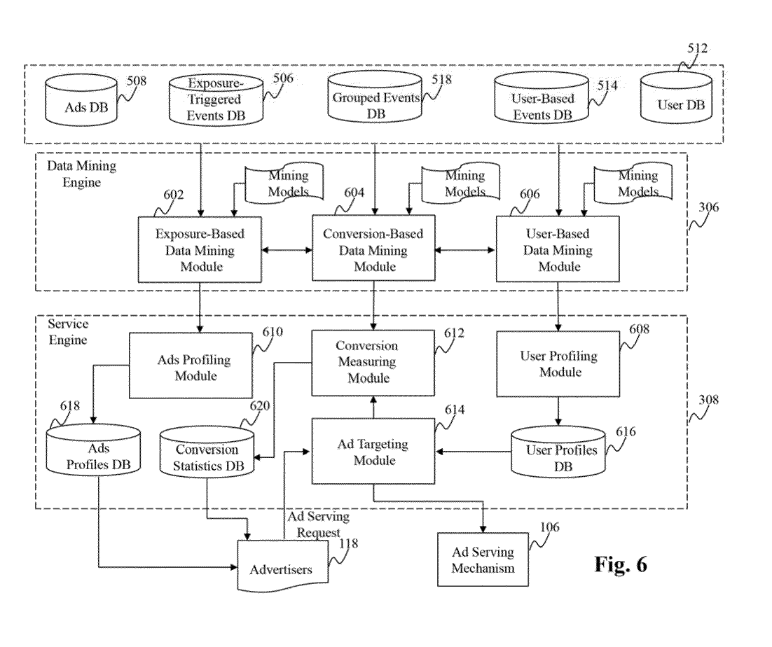

FIG. 6 depicts exemplary diagrams of the data mining engine 306 and service engine 308 in the system shown in FIG. 3, according to an embodiment of the present teaching. The data mining engine 306 includes a variety of data mining modules, such as an exposure-based data mining module 602, a conversion-based data mining module 604, and a user-based data mining module 606, each of which performs a data mining analysis based on a respective model. Each data mining module shares data sources with grouped events data stored in databases, such as the exposure-triggered events database 506, user-based events database 514, grouped events database 518, advertisement database 508, and user database 512. The exposure-based data mining module 602 analyzes events associated with the same exposure content (e.g., an advertisement). Data mining results from the exposure-based data mining module 602 may, for example, comprise information regarding popularity of an advertisement with respect to demographic groups, geographic regions, platforms, devices, serving time, etc. The conversion-based data mining module 604 focuses on analyzing events that trigger a particular conversion. For example, each time a particular product is purchased at a local or online store, the conversion-based data mining module 604 may analyze information related to the grouped events to find out whether the sale is triggered by an advertisement of the particular product presented to the same user who made the purchase. The user-based data mining module 606 analyzes user behaviors, such as purchase behaviors, of a particular user or a user group through all the events related to the same user or user group in order to determine the interests of the particular user or user group. It is understood that the data mining engine 306 may include additional (or alternative) modules that analyze the grouped events data based on any suitable data mining model. Moreover, for some analysis (e.g., advertisement conversion measurement), more than one data mining module may work together in order to achieve the desired results.

The data mining results obtained from the data mining engine 306 are provided to the service engine 308 for different applications. In this embodiment, the service engine 308 performs user profiling by a user profiling module 608, advertisement profiling by an advertisement profiling module 610, advertisement conversion measurement by a conversion measuring module 612, and targeted advertising by an advertisement targeting module 614. The user profiling module 608 determines a user's long-term and short-term interests of topics, brands, products, or services by looking into both the user's media consumption patterns obtained from the user's exposure events and also the user's purchase behaviors obtained from the user's conversion events. User profiles created and updated by the user profiling module 608 are stored in the user profiles database 616. Similarly, the advertisement profiling module 610 is responsible for creating profiles of each particular advertisement. The advertisement profile may include information about, for example, popularities of the advertisement with respect to demographic groups, geographic regions, platforms, devices, serving time, etc. The advertisement profiles may be stored in an advertisement profiles database 618 and provided to the advertisers 118 as desired.

The applications of the service engine 308 also include targeted advertising and conversion measurement in response to advertisement serving requests from the advertisers 118. The request may include information of the targeted users, such as demographic or lifestyle date of desired audience, or information related to the advertisement itself, such as the topic of the advertisement. Based on the information in the request, the advertisement targeting module 614 may determine targeted users by matching the request information with user profile information. The identified targeted users are then served with the advertisement by the advertisement serving mechanism 106. After the advertisement is served, the advertisement targeting module 614 notifies the conversion measuring module 612 about whom the targeted users are and which advertisement has been served such that the conversion measuring module 612 can track each targeted user's conversion events to identify all the conversion events that are triggered by the served advertisement. The tracked information and measured conversion rate are stored in a conversion statistics database 620 and fed back to the advertisers 118 about the effectiveness of the served advertisement.

More detailed disclosures of various aspects of the system 100 are covered in different U.S. patent applications entitled “METHOD AND SYSTEM FOR RECOMMENDING TARGETED TELEVISION PROGRAMS BASED ON ONLINE BEHAVIOR,” “METHOD AND SYSTEM FOR TARGETED ADVERTISING BASED ON ASSOCIATED ONLINE AND OFFLINE USER BEHAVIORS,” “METHOD AND SYSTEM FOR ADVERTISEMENT CONVERSION MEASUREMENT BASED ON ASSOCIATED DISCRETE USER ACTIVITIES,” and “METHOD AND SYSTEM FOR ASSOCIATING DISCRETE USER ACTIVITIES ON MOBILE DEVICES.”

The present teaching particularly relates to a system, method, and/or programs for targeted advertising and conversion measurement that address the shortcomings associated the conventional advertising solutions.

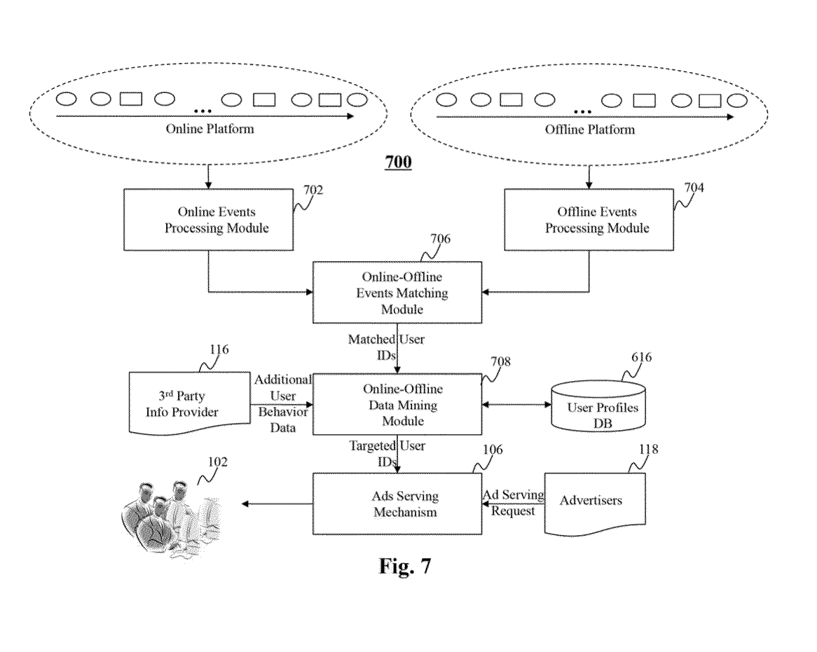

FIG. 7 depicts an exemplary diagram of a system 700 for targeted advertising based on associated online and offline behaviors, according to an embodiment of the present teaching. In this embodiment, the system 700 focuses on analyzing user events on the online and offline platforms and serving advertisements to targeted users based on the analysis results. For example, the system 700 may tie online advertisement impressions to actual offline sales to better understand users' media consumption and purchase behaviors. In an embodiment, the system 700 includes an online events processing module 702, an offline events processing module 704, an online-offline events matching module 706, and an online-offline data mining module 708.

The online events processing module 702 and offline events processing module 704 interface with user events occurring on the online and offline platforms, respectively. The online events processing module 704 is configured to receive information related to online activities of a user (e.g., a user event). The online activity includes, for example, an advertisement exposure event or an advertisement conversion event that occurs online at a website. The online activity is associated with one or more attributes to be used to identify the user, including, but not limited to, the user's identity (e.g., name), physical address, social security number, cookie, IP address, and user account. The online events processing module 702 may be implemented differently depending on the specific device on which a user event occurs. For example, on PCs or laptops, the online events processing module 702 may be a cookie registration application. On mobile devices or other environments in which traditional cookies are unavailable, the online events processing module 702 may comprise an application embedded in a webpage that monitors user activities on the webpage and generates a unique code for each user activity based on attributes of the user and/or the user's device. The offline events processing module 704 is configured to receive information related to offline activities of the user. The offline activity includes, for example, an advertisement exposure event or an advertisement conversion event that occurs offline, e.g., at a local store. The offline activity is also associated with one or more attributes to be used to identify the user, including, but not limited to, the user's identity, physical address, social security number, payment card number, and shopper card number. It is understood that the same or different attributes may be used by the online and offline events processing module 702, 704 in different examples.

The online-offline events matching module 706 in the system 700 is configured to identify connections between the online activities and offline activities of the same user or user group by matching the attributes associated with the online and offline activities. For example, name and address match may be conducted in order to match the online and offline events associated with the same user or users in the same household. For privacy and security concerns, in some examples, some attributes of a matched event, e.g., PII, are removed once the connections of the online and offline activities have been identified. The user or the user group is then assigned with a matched user ID, and all the events of the user or user groups are now associated with the matched user ID. All the user online and offline activities associated with the same matched user ID are sent to the online-offline data mining module 708 to build a new user profile or update an existing user profile of the corresponding user. The details of building user profile based on user online and offline behaviors have been described above with respect to FIG. 6. In this embodiment, the online-offline data mining module 708 may further retrieve additional user behavior data from the 3^{rd} party information provider 116 based on the matched user ID. The 3^{rd} party information provider 116 and the system 700 may use the same matched user ID to identify information related to a specific user or user group. It is understood that the system 700 continuously identifies connections between respective online and offline activities of a large number of users and creates or updates user profiles for each of the users based on the respective identified connections and online and offline user behaviors. All the user profiles are then stored in the user profiles database 616 and can be continuously or periodically updated as the system 700 keeps running.

The advertisement serving mechanism 106, upon receiving an advertisement serving request from an advertiser 118, forwards information related to the request to the online-offline data mining module 708. The information includes, for example, campaign objective, demographic information, user ID, publisher information, and advertisement information, to name a few. Use some or all of the information in the request as criteria, the online-offline data mining module 708 can search the user profiles database 616 to find out targeted users 102 with matched profiles. The targeted users 102 are provided to the advertisement serving mechanism 106 for targeted advertising.

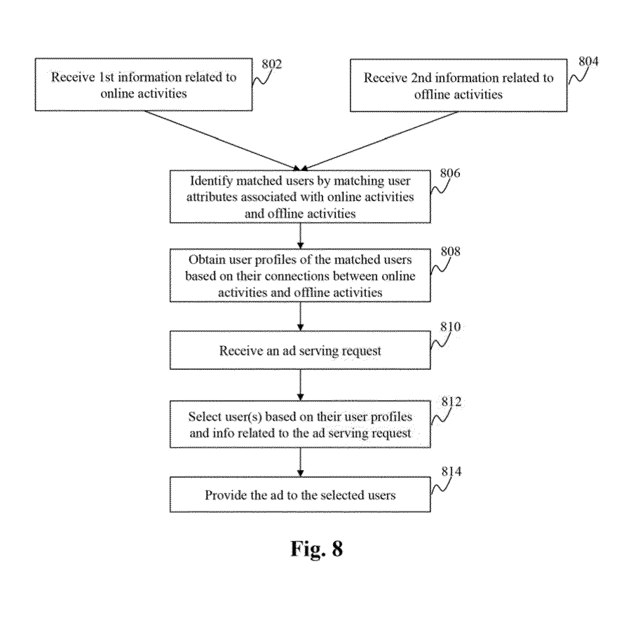

FIG. 8 is a flowchart of an exemplary process for targeted advertising based on associated online and offline behaviors, according to an embodiment of the present teaching. First and second information related to user online and offline activities are received at 802, 804, respectively. Each user activity is received with one or more user attributives that can be used to identify the respective user. The attributes may comprise PII or any other information, such as a cookie or IP address for online activities and shopper card number or payment card number for offline activities. Matched users are then identified, at 806, by matching user attributes associated with the online and offline activities. User profiles of each of the matched users are obtained, at 808, based on their connections between online and offline activities. Each user's online and offline activities constitute the user's online and offline behavior patterns and are used as a basis for building or updating the user's profile. At 810, an advertisement serving request is received from an advertiser or a publisher. The request is received with information, such as campaign objective, demographic information, user identifier, publisher information, and advertisement information. Based on such information and all the obtained user profiles, at 812, one or more targeted users are selected from the user pool, whose profiles match well with the request. At 814, the advertisement is provided to the selected targeted users.

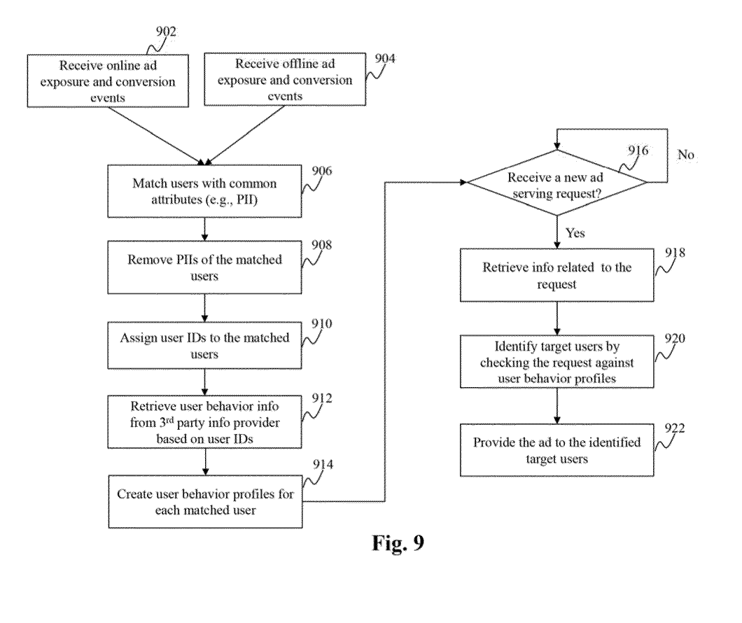

FIG. 9 is a flowchart of another exemplary process for targeted advertising based on associated online and offline behaviors, according to an embodiment of the present teaching. At 902, online advertisement exposure and conversion events are received. At 904, offline advertisement exposure and conversion event are received. Based on the common attributes associated with both online and offline events, such as PII or address, online and offline events associated with the same user are matched at 906. After matching, at 908, PIIs are removed from all the matched users for privacy and security concerns. At 910, a unique user ID is assigned to each matched user. Based on the assigned user ID, user behavior information is retrieved from a 3^{rd} party information provider, e.g., client relationship management (CRM) database, for each matched user at 912. At 914, based on the retrieved user behavior information and all the received online and offline events of the respective user, user behavior profiles are created for each matched user. At 916, it is determined whether a new advertisement serving request is received. If so, the process continues to 918, where information related to the request is received. Otherwise, the process returns to 916 to monitor any new incoming advertisement serving request. At 920, targeted users for advertisement serving are identified by checking the request against the user behavior profiles obtained at 914. The identified targeted users are then provided with the advertisement at 922.

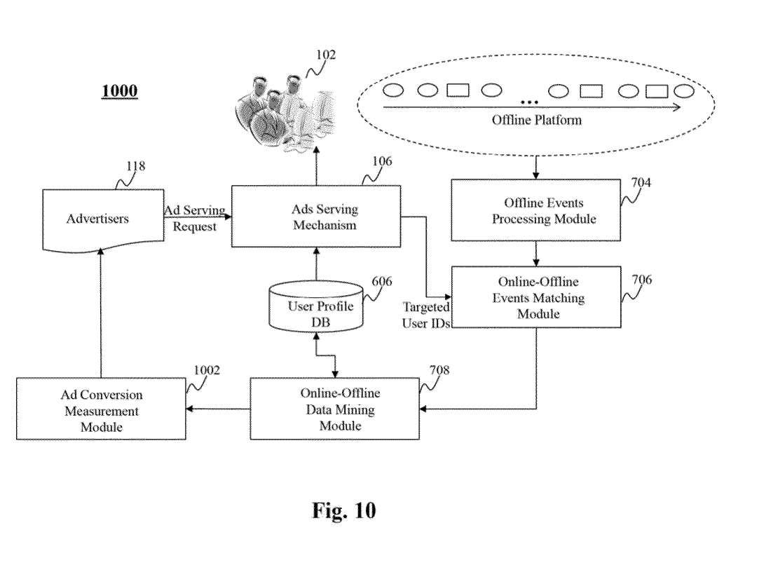

FIG. 10 depicts an exemplary diagram of a system 1000 for advertisement conversion measurement based on associated online and offline behaviors, according to an embodiment of the present teaching. For example, the system 1000 provides a closed-loop measurement of advertisement exposure to in-store purchase, which is hard to achieve using traditional means. In this embodiment, the advertisement serving mechanism 106 receives an advertisement serving request from an advertiser 118. The advertisement request includes information such as targeted user groups (e.g., demographic information), information of the advertisements (e.g., types of the advertisements), information of a publisher or particular user IDs, etc. Based on the advertisement serving request, the system 1000 identifies the targeted users 102 based on user profiles stored in the user profiles database 616. The targeted users 102 are served with the advertisement online by the advertisement serving mechanism 106. The online advertisement includes, for example, banner advertisement, video advertisement, or e-mail advertisement. Once the targeted users are identified, the system 1000 also extracts targeted user IDs (e.g., exposure tracking tags) and sends the targeted user IDs to the online-offline events matching module 706. The targeted user IDs are generated based on one or more attributes of each targeted user.

The offline events processing module 704 is configured to monitor all the user events on the offline platform to receive information related to offline activities. The offline events processing module 704 creates a user ID for each received offline activity based on one or more attributes of the respective user. The online-offline events matching module 706 then identifies offline events that are associated with each of the targeted users by matching the targeted user IDs with the user IDs of the corresponding offline events. The online-offline events matching module 706 then further identifies offline events that are also related to the advertisement exposure. The offline activities include, for example, offline transactions of a product that is shown in the advertisement. In this example, the online-offline events matching module 706 identifies the offline purchase activities of the targeted users to whom the advertisement has been exposed and matches the targeted users' offline purchase activities with their exposure to the online advertisement.

The matched results are sent to the online-offline data mining module 708 for updating the user profiles and are also sent to an advertisement conversion measurement module 1002 for calculating the conversion rate of the advertisement exposure. Based on the conversion rate, the advertisers 118 can have a better understanding of the effectiveness of the advertisement exposed to the online users. Accordingly, the system 1000 provides an improved ROI solution for the advertisers and/or publishers, in particular, by demonstrating that a particular set of advertisements led to the actual sale of a product or service. Based on the ROI solutions, the advertisers and/or publishers can optimize their advertisement serving strategies to achieve the highest yield.

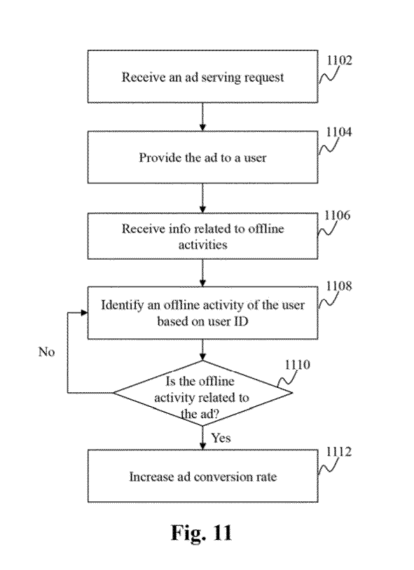

FIG. 11 is a flowchart of an exemplary process for advertisement conversion measurement based on associated online and offline behaviors, according to an embodiment of the present teaching. At 1102, an advertisement serving request is received from a marketer, such as an advertiser or a publisher. The request includes information such as campaign objective, demographic information, user identifier, publisher information, and advertisement information. Based on the request and user profiles, targeted users are identified and served with the advertisement online at 1104. Each targeted user is associated with a targeted user ID. The targeted user ID is generated based on at least one of user identity, physical address, social security number, cookie, IP address, and user account associated with the user profiles. At 1106, information related to offline activities, such as offline sale activities are received. Each offline activity is associated with a respective offline user ID. The offline user IDs are created based on at least one of user identity, physical address, social security number, payment card number, and shopper card number associated with the user profiles. At 1108, offline activities that are associated with one of the targeted users are identified by matching the target user IDs with offline user IDs. It is further determined, at 1110, whether an identified offline activity is related to the served advertisement. For example, it is determined whether the offline activity involves an offline transaction of a product or a service that is shown in the served advertisement. If not, the offline activity is disregarded and the process returns to 1108. If the answer at 1110 is yes, it means that the served online advertisement leads to an actual offline sale by the targeted user and thus, the conversion rate of the served online advertisement is increased accordingly at 1112. As such, links between online advertisement impression and offline sales are established by the process in FIG. 11.

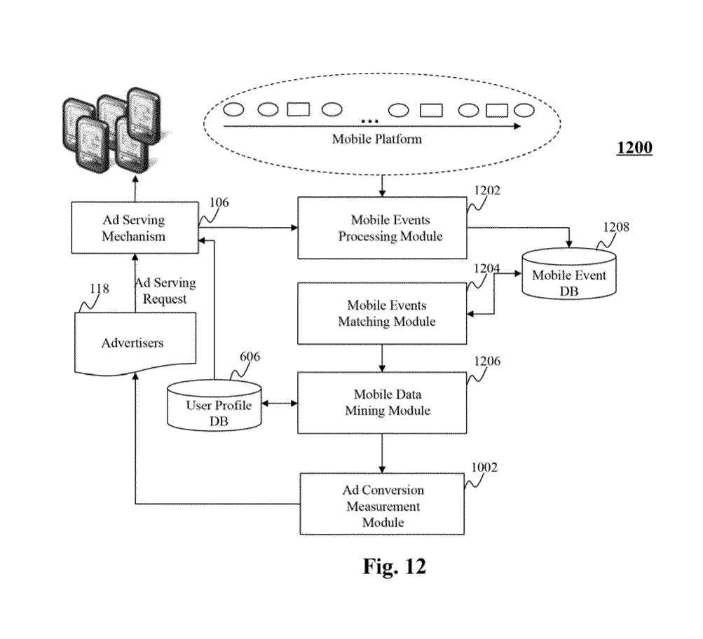

FIG. 12 depicts an exemplary diagram of a system 1200 for advertisement conversion measurement based on discrete user activities on mobile devices, according to an embodiment of the present teaching. The system 1200 in this embodiment is able to track user events created in the mobile setting without cookies and link the events to user activities on any platforms. The system 1200 includes a mobile events processing module 1202, a mobile events matching module 1204, a mobile data mining module 1206, and the advertisement conversion measurement module 1002. As described before, once an advertisement serving request is received by the advertisement serving mechanism 106 from an advertiser 118, targeted users whose user profiles match with the request are identified from the user profiles database 616. The targeted users are served with the advertisement on their mobile device, such as on a smartphone or a tablet. Unlike serving advertisement on a PC or a laptop computer, where the activities can be tracked by cookies, the breakage with cookies and the fact that mobile apps and mobile web are not synchronized create a gap in tracking the mobile events. Thus, the mobile events processing module 1202 is configured to create a unique user ID for each mobile event, either an exposure or conversion event, on the mobile platform based on one or more attributes of the mobile devices. The attributes include, for example, mobile device type, operating system, browser, IP address, and user agent. In this embodiment, a unique user ID (exposure ID) is created by the mobile events processing module 1202 for each advertisement serving event and stored in a mobile event database 1208.

After the advertisement is served, the mobile events processing module 1202 monitors all the user events on the mobile platform and creates a unique user ID for each of the received user mobile events in the same manner as it did for the advertisement exposure events. The unique user IDs are stored in the mobile events database 1208 as well. In this embodiment, the mobile events processing module 1202 is further configured to identify all the conversion events that are related to the served advertisement. The mobile events matching module 1204 is responsible for matching conversion IDs of the received conversion events with the exposure IDs. The results of the matching are sent to the mobile data mining module 1206 for updating the user profiles and are also sent to the advertisement conversion measurement module 1002 for counting the advertisement conversion rate. It is understood that although only the mobile platform is illustrated in FIG. 12, the conversion events are not limited to be on the mobile platform. Any events occurring on the online platform (non-mobile setting) or the offline platform can be processed by the online and offline events processing modules 702, 704, respectively, and matched with the exposure IDs created in the mobile setting in a similar manner as described above with respect to FIGS. 7-11. That is, the exposure events on the mobile platform in this embodiment can be matched with conversion events on any platforms, e.g., mobile platform, online platform (non-mobile setting), offline platform, TV platform, etc., for measuring advertisement conversion rate.

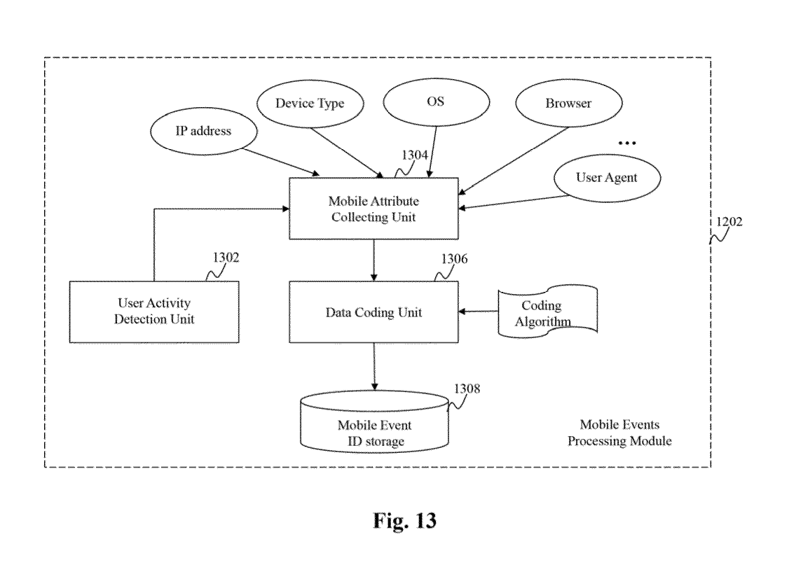

FIG. 13 depicts an exemplary diagram of the mobile events processing module 1202 in the system 1200 shown in FIG. 12, according to an embodiment of the present teaching. The mobile events processing module 1202 includes a user activity detection unit 1302, a mobile attribute collecting unit 1304, a data coding unit 1306, and mobile events ID storage 1308. The user activity detection unit 1302 is responsible for detecting any user activity on a mobile device with respect to a piece of content. The detection may be made in an in-app environment or in a web environment. The activities to be detected include, for example, presenting an advertisement to a user on a mobile device, a user's explicit or implicit interactions with the advertisement, e.g., clicking, scrolling through, hovering over, forwarding, liking/dislike, commenting, navigating to a different website, etc., and transaction-related activities, e.g., loading purchase confirmation page, receiving sale receipt through e-mails, etc. Each of the detected user activities acts as a triggering event for activating the mobile attribute collecting unit 1304 to collect predefined one or more attributes of the mobile device, including, but not limited to, IP address, device type, operating system, browser, and user agent. Based on the collected attribute(s), the data coding unit 1306 is configured to create a unique user ID according to a coding algorithm, e.g., the hash function. In this embodiment, the same coding algorithm and attribute(s) are used for creating the unique user IDs for all the mobile events. As a result, all the user events occurring on the same user device have the same user IDs and thus, can be matched based on their user IDs. The mobile event IDs are stored in the mobile event ID storage 1308.

In one example, the mobile events processing module 1202 may be implemented as an application, e.g., script, embedded in a webpage. The webpage may be a webpage on which the advertisement is presented or a webpage on which a transaction of the advertised product or service can be conducted. For example, the webpage may the advertiser's own page, a publisher's webpage where the advertisement is published, or an e-commerce site where the advertised product or service can be purchased. The user can access to the webpage either through a web browser or any mobile apps on the mobile device. For example, an embedded script may use unique signals on the user's browser and HTTP requests to generate a unique ID for that user. In one example, the unique ID is a hashed (SHA-1) combo of IDFA, user agent, and IP address, among others. One example of the unique ID is Mozilla/5.0 (iPhone; CPU iPhone OS 5_{—}0_{—}1 like Mac OS X) AppleWebKit/534.46 (KHTML, like Gecko) Mobile/9AA405+209.124.171.9----SHA-1--->8c02511bf16749d790bf491498e ae5c20e0a1b3a

The unique user ID may be created in response to an exposure event, such as serving the advertisement to the user. The creation of unique user ID may be also triggered by a click-based conversion, e.g., clicking the advertisement and automatically taken to the advertiser's webpage, a view-through (non-clicking) conversion, e.g., navigating to the advertiser's webpage without clicking on the advertisement, or a transaction conversion, e.g., loading the confirmation page of purchasing the advertised product or service. The user IDs for both the exposure and conversion events are created using the same algorithm and attribute(s). It is understood that there can be any arbitrary number of intermediate pages between the exposure page and the conversion page when the user IDs are created for the respective exposure and conversion events on the mobile platform.

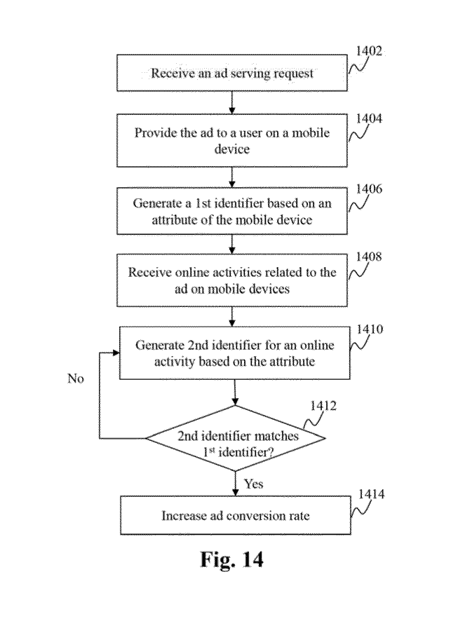

FIG. 14 is a flowchart of an exemplary process for advertisement conversion measurement based on discrete user activities on mobile devices, according to an embodiment of the present teaching. At 1402, an advertisement serving request is received. Targeted users are identified based on their user profiles and the request. The advertisement is provided to the targeted users on their mobile devices at 1404. For each of the advertisement exposure events on the mobile devices, a first user ID (e.g., exposure ID) is generated, at 1406, based on an attribute of the mobile device, such as, for example, mobile device type, operating system, browser, IP address, or user agent. Online activities on mobile devices related to the served advertisement are received at 1408. For a received online activity, a corresponding second user ID (e.g., conversion ID) is generated, at 1410, based on the same attribute that has been used to generate the first user ID. At 1412, the second user ID is compared with the first user ID of the exposure event to find a match. If there is no match, then the process returns to 1410 to generate the second user ID for the next received online activity. Each time a match is identified at 1412, the conversion rate of the served advertisement is increased at 1414. In one example, the received online activities are conversion events that are triggered by the served advertisement, such as a transaction of product or serviced in the advertisement.

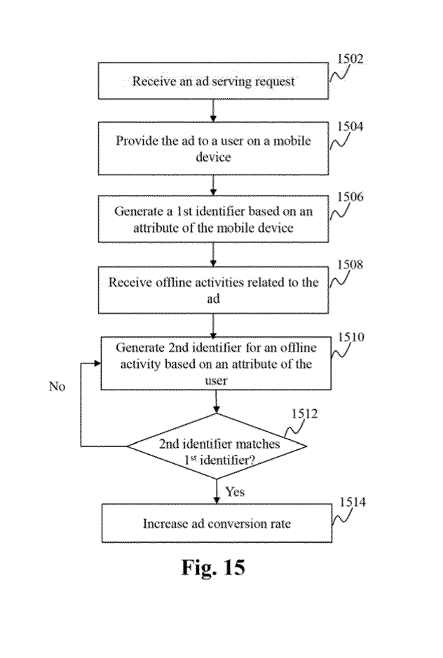

FIG. 15 is a flowchart of an exemplary process for advertisement conversion measurement based on discrete user activities on mobile devices and offline user activities, according to an embodiment of the present teaching. At 1502, an advertisement serving request is received. Targeted users are identified based on their user profiles and the request. The advertisement is provided to the targeted users on their mobile devices at 1504. For each of the advertisement exposure events on the mobile devices, a first user ID (e.g., exposure ID) is generated, at 1506, based on an attribute of the mobile device, such as, for example, mobile device type, operating system, browser, IP address, and user agent. At 1508, offline activities related to the served advertisement are received. For example, the offline activities include in-store purchase of a product or service in the advertisement. A second ID (e.g., conversion ID) is generated, at 1510, for an offline activity based on an attribute of the user, such as PII. At 1512, an offline process is used to determine whether there is a match between the first and second IDs. If there is a match, then a successful advertisement conversion is counted at 1514. Otherwise, the process returns to 1510 for the next offline activity.

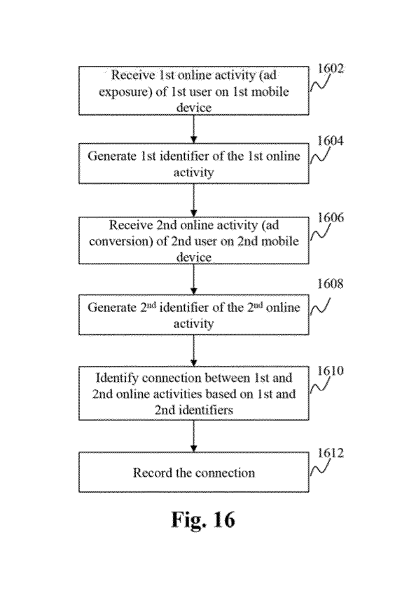

FIG. 16 is a flowchart of an exemplary process for associating discrete user online activities on mobile devices, according to an embodiment of the present teaching. A first online activity of a first user, e.g., an advertisement exposure event, is received, at 1602, on a first mobile device. The advertisement exposure event may be received by an application embedded in a publisher's webpage where the advertisement is presented in an in-app or web environment on the first mobile device. At 1604, a first ID of the first online activity is generated. The first ID is generated based on one or more attributes of the first mobile device using a coding algorithm, such as the hash function. A second online activity of a second user, e.g., an advertisement conversion event, is received, at 1606, on a second mobile device. The advertisement conversion event may be received by an application embedded in the advertiser's webpage or in an e-commerce webpage on which the advertised product or service can be purchased in an in-app or web environment on the second mobile device. At 1608, a second ID of the second online activity is generated. The first and second IDs are generated based on the same attributes and using the same coding algorithm. Connections between the first and second online activities are identified, at 1610, based on the first and second IDs. As the first and second IDs are generated using the same conditions, e.g., attributes and coding algorithm, a match between the first and second IDs indicates that the first and second online activities are associated with the same user and/or occur on the same mobile device. At 1612, the identified connections are recorded. Accordingly, discrete user events in the mobile setting are tied together by the attribute-based IDs without the need of cookies.

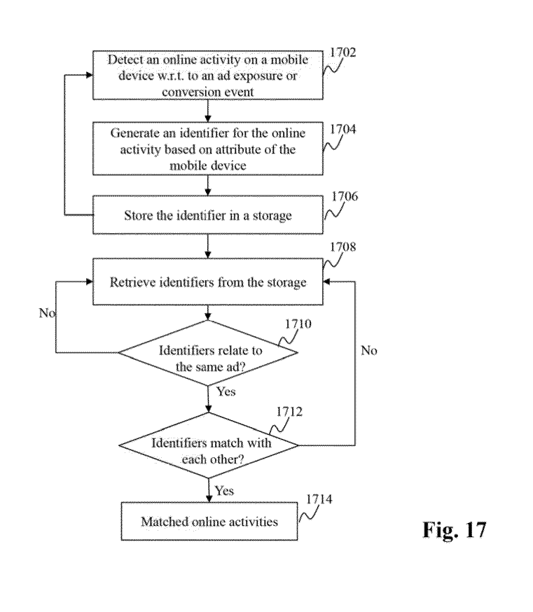

FIG. 17 is a flowchart of another exemplary process for associating discrete user online activities on mobile devices, according to an embodiment of the present teaching. At 1702, an online activity on a mobile device with respect to an advertisement exposure or conversion event is detected. An ID is generated, at 1704, for the online activity based on attribute of the mobile device. The ID of the online activity is stored in storage at 1706. 1702 to 1706 run in a continuous manner to expand the IDs in the storage. At 1708, two or more IDs are retrieved from the storage to determine whether any of the corresponding online activities on the mobile platform are related to each other. It is determined at 1710, whether the online activities corresponding to the IDs are related to the same advertisement, e.g., exposure of the same advertisement or conversion triggered by the same advertisement. If the answer is yes, the process continues to 1712, where whether any of the retrieved IDs are matched with each other is determined. If a match of two or more IDs is found, then the corresponding online activities are matched at 1714. Otherwise, the process returns back to 1708 to check a different set of IDs.

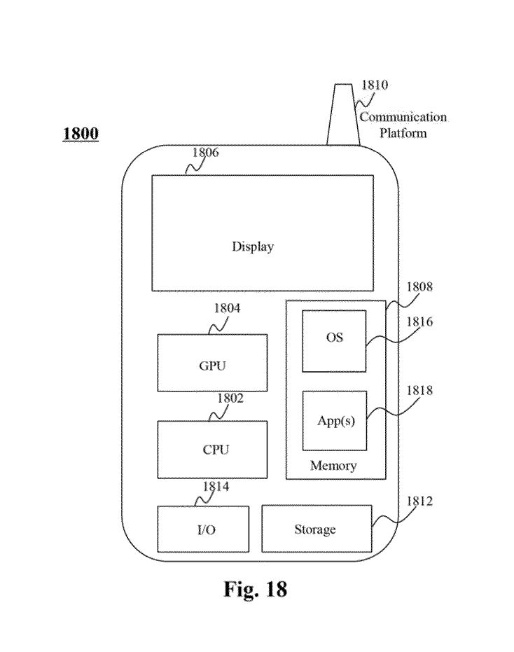

FIG. 18 depicts a general mobile device architecture on which the present teaching can be implemented. In this example, the user device on which advertisement is presented is a mobile device 1800, including but is not limited to, a smart phone, a tablet, a music player, a handled gaming console, a global positioning system (GPS) receiver. The mobile device 1800 in this example includes one or more central processing units (CPUs) 1802, one or more graphic processing units (GPUs) 1804, a display 1806, a memory 1808, a communication platform 1810, such as a wireless communication module, storage 1812, and one or more input/output (I/O) devices 1814. Any other suitable component, such as but not limited to a system bus or a controller (not shown), may also be included in the mobile device 1800. As shown in FIG. 18, a mobile operating system 1816, e.g., iOS, Android, Windows Phone, etc., and one or more applications 1818 may be loaded into the memory 1808 from the storage 1812 in order to be executed by the CPU 1802. The applications 1818 may include a browser or any other suitable mobile apps for receiving and rendering content, such as advertisements, on the mobile device 1800. Execution of the applications 1818 may cause the mobile device 1800 to perform the processes as described above in the present teaching. For example, the display of advertisements to users may be made by the GPU 1804 in conjunction with the display 1806. User interactions with the advertisements may be achieved via the I/O devices 1814 and provided to the system via the communication platform 1810.

To implement the present teaching, computer hardware platforms may be used as the hardware platform(s) for one or more of the elements described herein. The hardware elements, operating systems, and programming languages of such computers are conventional in nature, and it is presumed that those skilled in the art are adequately familiar therewith to adapt those technologies to implement the processing essentially as described herein. A computer with user interface elements may be used to implement a personal computer (PC) or other type of work station or terminal device, although a computer may also act as a server if appropriately programmed. It is believed that those skilled in the art are familiar with the structure, programming, and general operation of such computer equipment and as a result the drawings should be self-explanatory.

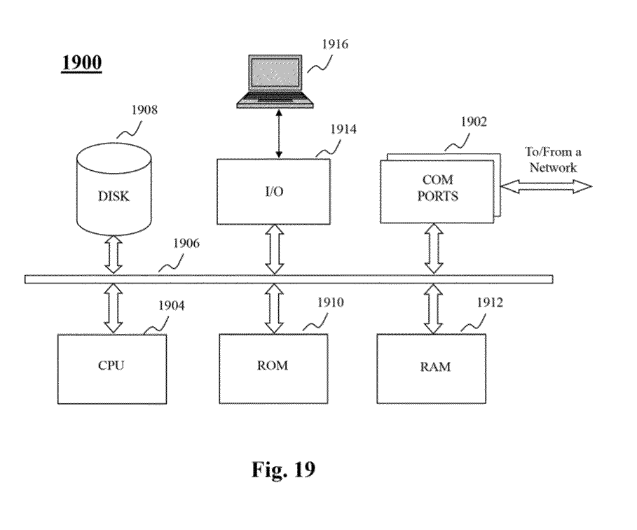

FIG. 19 depicts a general computer architecture on which the present teaching can be implemented and has a functional block diagram illustration of a computer hardware platform that includes user interface elements. The computer may be a general-purpose computer or a special purpose computer. This computer 1900 can be used to implement any components of the targeted advertising and conversion measurement architecture as described herein. Different components of the system in the present teaching can all be implemented on one or more computers such as computer 1900, via its hardware, software program, firmware, or a combination thereof. Although only one such computer is shown, for convenience, the computer functions relating to targeted advertising and conversion measurement may be implemented in a distributed fashion on a number of similar platforms, to distribute the processing load.

The computer 1900, for example, includes COM ports 1902 connected to and from a network connected thereto to facilitate data communications. The computer 1900 also includes a central processing unit (CPU) 1904, in the form of one or more processors, for executing program instructions. The exemplary computer platform includes an internal communication bus 1906, program storage and data storage of different forms, e.g., disk 1908, read only memory (ROM) 1910, or random access memory (RAM) 1912, for various data files to be processed and/or communicated by the computer, as well as possibly program instructions to be executed by the CPU 1904. The computer 1900 also includes an I/O component 1914, supporting input/output flows between the computer and other components therein such as user interface elements 1916. The computer 1900 may also receive programming and data via network communications.

Hence, aspects of the method of targeted advertising and conversion measurement, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will recognize that the present teaching is amenable to a variety of modifications and/or enhancements. For example, although the implementation of various components described above may be embodied in a hardware device, it can also be implemented as a software only solution. In addition, the components of the system as disclosed herein can be implemented as a firmware, firmware/software combination, firmware/hardware combination, or a hardware/firmware/software combination.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teaching.

We claim:

1. A method implemented on at least one machine, each of which has at least one processor, storage, and a communication platform connected to a network for targeted advertising, the method comprising the steps of:
receiving first information related to an online activity of a user, wherein the online activity is associated with a first attribute to be used to identify the user;
receiving second information related to an offline activity of the user, wherein the offline activity is associated with a second attribute to be used to identify the user;
identifying a connection between the online activity and the offline activity of the user by matching the first attribute with the second attribute;
obtaining a profile of the user based, at least in part, on the identified connection;
receiving a request of serving an advertisement;
selecting the user from a plurality of users based on the profile of the user and information related to the request; and
providing the advertisement to the user.

2. The method of claim 1, wherein
the online activity includes an advertisement exposure event or an advertisement conversion event that occurs online; and
the offline activity includes an advertisement exposure event or an advertisement conversion event that occurs offline.

3. The method of claim 1, wherein
the first attribute includes at least one of identity, physical address, social security number, cookie, IP address, and user account; and
the second attribute includes at least one of identity, physical address, social security number, payment card number, and shopper card number.

4. The method of claim 1, further comprising:
upon identifying the connection between the online activity and the offline activity of the user, removing personally identifiable information (PII) associated with the user from the connection; and
assigning an identifier to the user.

5. The method of claim 4, further comprising:
receiving user behavior information related to the user from a third-party information provider based on the identifier of the user, wherein the profile of the user is obtained based, at least in part, on the received user behavior information.

6. The method of claim 1, further comprising:
for each of the plurality of users, identifying a connection between respective online activity and offline activity of the respective user by matching the first attribute with the second attribute; and
obtaining a profile of the respective user based, at least in part, on the respective identified connection.

7. The method of claim 1, wherein the information related to the request includes at least one of campaign objective, demographic information, user identifier, publisher information, and advertisement information.

8. A method implemented on at least one machine, each of which has at least one processor, storage, and a communication platform connected to a network for advertisement conversion measurement, the method comprising the steps of:
receiving a request of serving an advertisement;
providing the advertisement to a user based on information related to the request and a profile of the user, wherein the user is associated with a first identifier;
receiving information related to offline activities of the user, wherein each of the offline activities is identified based on the first identifier associated with the user;
identifying at least one offline activity of the user from the received information, wherein the at least one offline activity relates to an event associated with the advertisement; and
determining a measure of serving the advertisement based on the identified at least one offline activity of the user.

9. The method of claim 8, wherein the offline activity includes an offline transaction of a product or a service that is related to the advertisement.

10. The method of claim 8, wherein the first identifier is generated based on at least one of identity, physical address, social security number, cookie, IP address, user account.

11. The method of claim 8, wherein the information related to the request includes at least one of campaign objective, demographic information, user identifier, publisher information, and advertisement information.

12. The method of claim 8, wherein
each of the offline activities is associated with a respective second identifier; and
each of the offline activities is identified based on matching the first identifier with a respective second identifier.

13. The method of claim 12, wherein the second identifier is generated based on at least one of identity, physical address, social security number, payment card number, and shopper card number.

14. The method of claim 8, wherein the advertisement is provided to the user online.

15. The method of claim 8, further comprising:
selecting the user from a plurality of users based on the profile of the user and information related to the request.

16. The method of claim 15, wherein selecting the user from a plurality of users comprises:
receiving first information related to an online activity of the user, wherein the online activity is associated with a first attribute to be used to identify the user;
receiving second information related to an offline activity of the user, wherein the offline activity is associated with a second attribute to be used to identify the user;
identifying a connection between the online activity and the offline activity of the user by matching the first attribute with the second attribute;
obtaining the profile of the user based, at least in part, on the identified connection.

17. A system having at least one processor, storage, and a communication platform for targeted advertising, the system comprising:
an online events processing module configured to receive first information related to an online activity of a user, wherein the online activity is associated with a first attribute to be used to identify the user;
an offline events processing module configured to receive second information related to an offline activity of the user, wherein the offline activity is associated with a second attribute to be used to identify the user;
an online-offline events matching module configured to identify a connection between the online activity and the offline activity of the user by matching the first attribute with the second attribute;
an online-offline data mining module configured to obtain a profile of the user based, at least in part, on the identified connection; and
an advertisement serving module configured to receive a request of serving an advertisement, select the user from a plurality of users based on the profile of the user and information related to the request, and provide the advertisement to the user.

18. A system having at least one processor, storage, and a communication platform for advertisement conversion measurement, the system comprising:
an advertisement serving module configured to receive a request of serving an advertisement, and provide the advertisement to a user based on information related to the request and a profile of the user, wherein the user is associated with a first identifier;
an offline events processing module configured to receive information related to offline activities of the user, wherein each of the offline activities is identified based on the first identifier associated with the user;
an events matching module configured to identify at least one offline activity of the user from the received information, wherein the at least one offline activity relates to an event associated with the advertisement; and
an advertisement conversion measurement module configured to determine a measure of serving the advertisement based on the identified at least one offline activity of the user.

19. A non-transitory machine-readable medium having information recorded thereon for targeted advertising, wherein the information, when read by the machine, causes the machine to perform the following:
receiving first information related to an online activity of a user, wherein the online activity is associated with a first attribute to be used to identify the user;
receiving second information related to an offline activity of the user, wherein the offline activity is associated with a second attribute to be used to identify the user;
identifying a connection between the online activity and the offline activity of the user by matching the first attribute with the second attribute;
obtaining a profile of the user based, at least in part, on the identified connection;
receiving a request of serving an advertisement;
selecting the user from a plurality of users based on the profile of the user and information related to the request; and
providing the advertisement to the user.

20. A non-transitory machine-readable medium having information recorded thereon for advertisement conversion measurement, wherein the information, when read by the machine, causes the machine to perform the following:
receiving a request of serving an advertisement;
providing the advertisement to a user based on information related to the request and a profile of the user, wherein the user is associated with a first identifier;
receiving information related to offline activities of the user, wherein each of the offline activities is identified based on the first identifier associated with the user;
identifying at least one offline activity of the user from the received information, wherein the at least one offline activity relates to an event associated with the advertisement; and
determining a measure of serving the advertisement based on the identified at least one offline activity of the user.
